(19) United States
(12) Patent Application Publication
(10) Pub. No.: US 2016/0253298 A1
(43) Pub. Date: Sep. 1, 2016

(54) Photo and Document Integration

(71) Applicant: EMPIRE TECHNOLOGY DEVELOPMENT LLC, Wilmington, DE (US)

(72) Inventor: Seungil Kim, Seoul (KR)

(21) Appl. No.: 14/388,551

(22) PCT Filed: Feb. 26, 2014
(86) PCT No.: PCT/US14/18569

§ 371 Date: Sep. 26, 2014

(51) Int. Cl. G06F 17/24; G06F 3/0486; H04N 5/232

(52) U.S. Cl. CPC G06F 17/24; H04N 5/23293; G06F 3/0486

(57) ABSTRACT

Technologies are generally described for a integrating pictures and documents. In some examples, a user device may receive a request for inserting a future picture into a document; determine an area within the document in which to insert the future picture; and display a camera view-finder in the determined area.

### BACKGROUND

Development of portable electronic devices (such as smartphones) has made it possible for users to prepare and edit documents at virtually anytime and at any location.

### SUMMARY

In an example, a method performed under control of a user device may include receiving a request for inserting a future picture into a document; determining an area within the document in which to insert the future picture; and displaying a camera viewfinder in the determined area.

In another example, a document editor apparatus may include a receiver configured to receive an instruction to insert a future picture into a document; a picture area manager configured to determine an area within the document in which to insert the future picture; and a display controller configured to instruct a display to display a camera viewfinder in the determined area.

In yet another example, a computer-readable storage medium may store thereon computer-executable instructions that, in response to execution, cause a user device to perform operations, including determining an area within a document in which to insert a future picture; finding an aspect ratio of the determined area; adjusting a picture signal from a camera based, at least in part, on the aspect ratio; and displaying, in the determined area, a camera viewfinder showing the adjusted picture signal.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIGS. 1A and 1B show examples of screenshots of a display of a user device that may display a document in which a picture may be inserted, arranged in accordance with at least some embodiments described herein;

FIGS. 2A and 2B shows example representations of a picture signal from a camera, arranged in accordance with at least some embodiments described herein;

FIGS. 3A to 3C show examples of screenshots of a display of a user device that may display a camera viewfinder within a document, arranged in accordance with at least some embodiments described herein;

FIG. 4 shows a block diagram of an example architecture of a user device configured to implement a photo insertion scheme, arranged in accordance with at least some embodiments described herein;

FIG. 5 shows a block diagram of another example architecture of a user device configured to implement a photo insertion scheme, arranged in accordance with at least some embodiments described herein;

FIG. 6 shows a block diagram of an example architecture of a picture insertion manager to implement a photo insertion scheme, arranged in accordance with at least some embodiments described herein;

FIG. 7 shows an example flow diagram of a process to implement a photo insertion scheme, arranged in accordance with at least some embodiments described herein;

FIG. 8 illustrates an example computer program product that may be utilized to implement a photo insertion scheme, arranged in accordance with at least some embodiments described herein; and

FIG. 9 is a block diagram illustrating an example computing device that may be utilized to implement a picture insertion scheme, arranged in accordance with at least some embodiments described herein.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the drawings, can be arranged, substituted, combined, separated, and designed in a wide variety of different configurations, all of which are explicitly contemplated herein.

This disclosure is generally drawn, inter alia, to methods, apparatuses, systems, devices, and computer program products related to integrating pictures and documents. Further, technologies are herein generally described for displaying a camera viewfinder in a determined area of a document to insert a picture of a subject displayed in the camera viewfinder into the determined area.

In some examples, a user device may be configured to execute a word processing program, on which a document may be prepared and a picture captured by the user device may be integrated into the document. Further, the user device may receive a user input to identify a location in the document at which the captured picture is to be integrated or placed. By way of example, but not limitation, the location at which the captured picture may be integrated or placed may be identified using a pointing-and-dragging input (i.e., the placement within the document may be identified using a finger or touch input on a display surface of the user device, or placement within the document may be identified by receiving a user input via, for example, a mouse, a keyboard, a touch pen, etc.). The user device may then determine the area for the captured picture based, at least in part, on the user input.

In some examples, the user device may find an aspect ratio of the determined area and adjust a picture signal from a camera based, at least in part, on the aspect ratio. As referenced herein, a picture signal may refer to a continuous image signal being captured by and transmitted from the camera to be displayed on a camera viewfinder. The adjusted picture signal may be displayed on the determined area as a camera viewfinder through which a user of the user device may view a subject in front of the camera. When a picture of the subject is then captured using the camera functionality of the user device, the captured picture may be adjusted to fit into the determined area within the document.

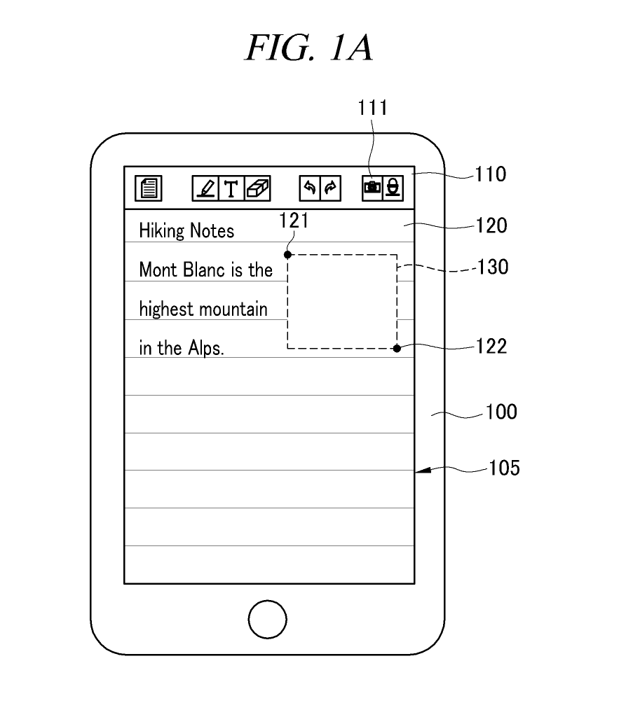

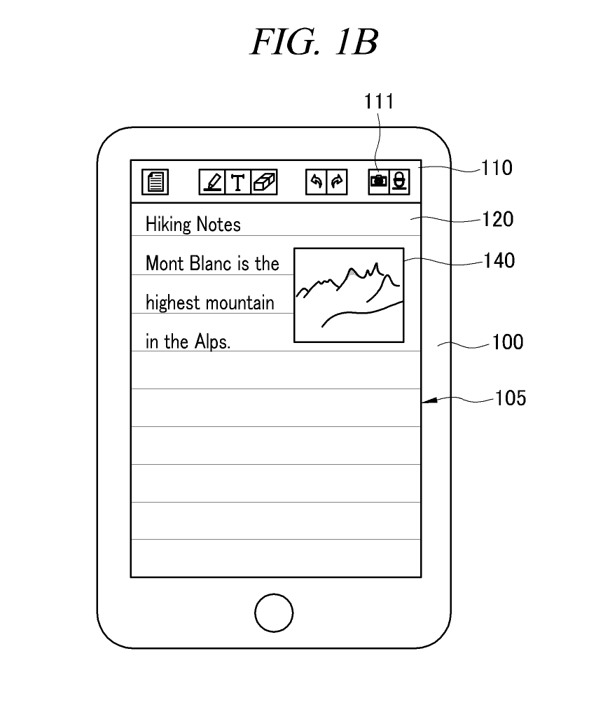

FIGS. 1A and 1B show examples of screenshots 105 of a display of a user device 100 that may display a document 120 in which a picture may be inserted, arranged in accordance with at least some embodiments described herein.

Screenshot 105 of FIG. 1A shows a screenshot of a GUI (“Graphic User Interface”) of a word processing program that may be executed on user device 100 to prepare and/or edit a document. As depicted in FIG. 1A, the GUI of the word processing program may include a tool bar 110 and document 120. Tool bar 110 may include one or more buttons that may be selected or clicked to activate respective functions such as, for example, a font modification function, an undo function, a camera function, etc. As depicted, tool bar 110 may include a camera button 111, which may initiate or activate a camera function on user device 100 to capture and insert a picture within document 120. Although the GUI of the document editor program described with reference to FIG. 1A includes tool bar 110 and document 120, one skilled in the art would appreciate any other graphic user interface designs associated with available word processing programs may be used with regard to the present disclosure.

User device 100 may be configured to execute the word processing program by which a user input may be received to create, edit and/or store document 120 in a memory (which may be a local memory or a remote memory such as, for example, a cloud datacenter). Further, user device 100 may be configured to capture a picture using a camera and display the captured picture and/or the GUI of the document editor program in a display. The camera and/or the display may be a part of user device 100 or a separate unit that is operatively coupled to user device 100.

User device 100 may be any type of electronic device configured to perform operations described in the present disclosure. By way of example, but not limitation, user device 100 may include a smartphone, a mobile phone, a personal digital assistant (PDA), a tablet, a hybrid of the aforementioned devices, a personal computer such as a laptop computer or a desktop computer, a television, a gaming console, etc.

As depicted in the example of FIG. 1A, document 120 regarding “Hiking Notes” may be prepared by a user of user device 100. While preparing document 120, the user may want to insert a picture relating to the notes (i.e., “Mont Blanc is the highest mountain in the Alps”). In some embodiments, user device 100 may be configured to receive a user input that indicates an intention to insert a picture into document 120. By way of example, but not limitation, if the user selects or clicks camera button 111, he/she may be allowed to specify an area 130 within document 120 in which to insert a picture that is stored on user device 100 or has yet to be received or captured by user device 100. The user's input for selecting or clicking camera button 111 and/or specifying area 130 may include, but not be limited thereto, a finger touch input on the display of user device 100 or a user input using, for example, a touch pen, a mouse, a keyboard, etc., using a pointing-and-dragging input (i.e., the placement within the document may be identified using a finger or touch input on a display surface of the user device, or placement within the document may be identified by receiving a user input via, for example, a mouse, a keyboard, a touch pen, etc.).

In some embodiments, user device 100 may be configured to determine area 130 using a pointing-and-dragging input. By way of example, but not limitation, the user may select a point 121 using a touch input on a surface of the display of user device 100, and then drag his/her finger along the surface of the display to a point 122 and detach his/her finger from the surface of the display at point 122. That is, the user may use a touch input to zoom in or zoom out to identify boundaries of the picture to be inserted. Alternatively and/or additionally, the user may use a user input device to select and/or specify points 121 and 122. User device 100 may be configured to identify coordinates of points 121 and 122 to determine area 130 within document 120. In some embodiments, user device 100 may be configured to find an aspect ratio of determined area 130. In such cases, user device 100 may calculate the aspect ratio of determined area 130 based on the coordinates of points 121 and 122. By way of example, but not limitation, when the coordinate of point 121 is (X1, Y1) and the coordinate of point 122 is (X2, Y2), the aspect ratio of determined area 130 may be obtained using the below formula.

Aspect Ratio=(X2−X1):(Y2−Y1)

User device 100 may then be configured to use the aspect ratio of determined area 130 to adjust a picture signal from a camera, which will be described below more in details. Alternatively and/or additionally, when the user specifies the shape of area 130 to be a shape other than a rectangle (such as, for example, a diamond, a circle, an ellipse, a triangle, a user-drawn shape etc.), user device 100 may be configured to determine area 130 in accordance with the user specified shape.

Although determined area 130 in which to insert the future picture is shown as a rectangle in FIG. 1A, the shape of determined area 130 is not limited thereto. In some other embodiments, the user may specify the shape of determined area 130 to be a shape other than a rectangle (such as, for example, a diamond, a circle, an ellipse, a triangle, etc.) using functionalities provided by the word processing program, and such functionalities are not described herein since those are readily understood by those skilled in the art.

In some embodiments, user device 100 may be configured to display a camera viewfinder 140 (which correspond to determined area 130 of FIG. 1A), as depicted in FIG. 1B, so that the user of user device 100 may be allowed to view a subject for which a picture is being taken using the camera function of user device 100 or by a camera that is communicatively connected to user device 100. The size and/or shape of determined area 130 may be different from those of an original picture taken by the camera. Thus, user device 100 may be configured to adjust a picture signal from the camera based, at least in part, on the aspect ratio of determined area 130. Alternatively and/or additionally, when the user specifies the shape of determined area 130 to be a shape other than a rectangle (such as, for example, a diamond, a circle, an ellipse, a triangle, a user-drawn shape etc.), user device 100 may be configured to crop the picture signal in accordance with the user specified shape. User device 100 may then be configured to display the adjusted picture signal as camera viewfinder 130 in determined area 130 within document 120.

In some examples, camera viewfinder 140 may display a subject that is in front of the camera corresponding to user device 100. As the camera moves or as the focus of the camera changes, so does the image displayed in viewfinder 140. A picture of the subject may be captured as camera button 111 is selected or clicked. In some examples, user device 100 may be configured to display a shutter button on camera viewfinder 140 so that the user of user device 100 may touch and/or click the shutter button to capture a picture. User device 100 may then be configured to insert the captured picture into determined area 130 within document 120. That is, the captured picture may be directly input to document 120.

In some embodiments, user device 100 may use an external camera application (such as, for example, a native camera application provided by a manufacturer of user device 100) to get a picture signal from the camera. In such cases, user device 100 may be configured to execute the external camera application. User device 100 may then downscale a screen display of the external camera application and overlay the downscaled screen display on document 120. By way of example, but not limitation, user device 100 may be configured to downscale the screen display of the external camera application to be the smallest one in which camera viewfinder 140 can be included and overlay the downscaled screen display on camera viewfinder 140. Among the overlaid screen display, a portion corresponding to camera viewfinder 140 may be displayed to be transparent such that the picture signal from the camera is shown as being clear, while other portions may be displayed to be other than transparent (e.g., semi-transparent, in a different color, etc.).

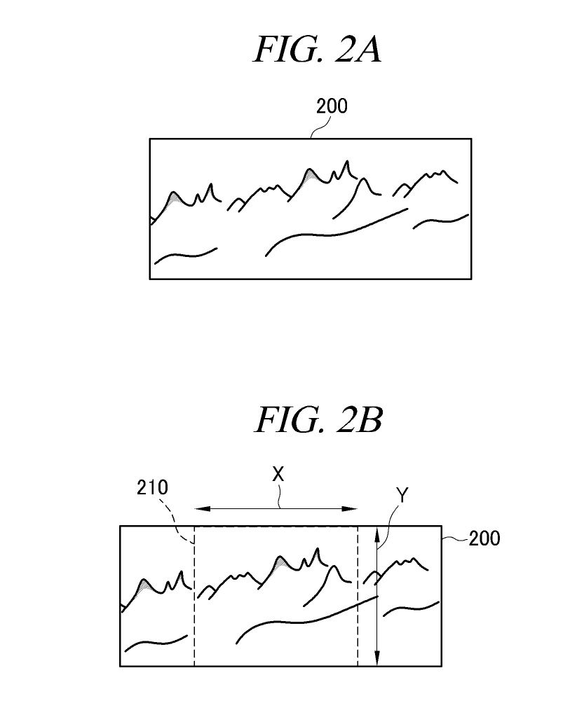

FIGS. 2A and 2B shows example representations of a picture signal 200 from a camera, arranged in accordance with at least some embodiments described herein. Reference may be made to the embodiments depicted and described with reference to FIG. 1.

As depicted in FIG. 2A, the camera associated with the user device may capture and generate picture signal 200 to be a predetermined size at a predetermined aspect ratio. In some embodiments, the user device may be configured to crop picture signal 200 in accordance with the size and/or the aspect ratio (X:Y as indicated in FIG. 2B) of determined area 130 to generate adjusted picture signal 210. The user device may then be configured to display adjusted picture signal 210 as camera viewfinder 130 in determined area 130 within document 120.

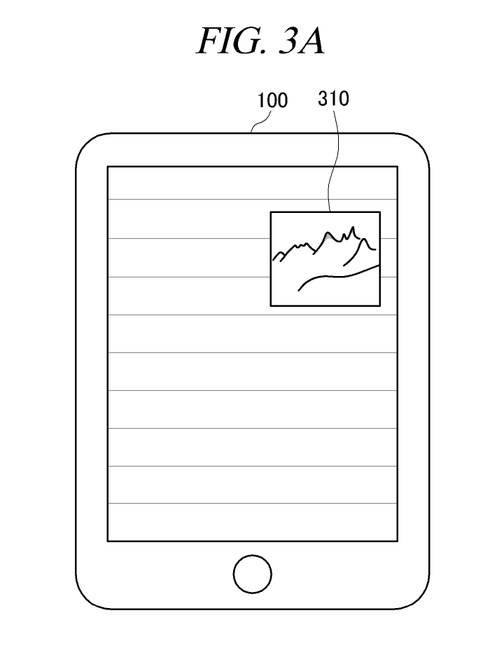

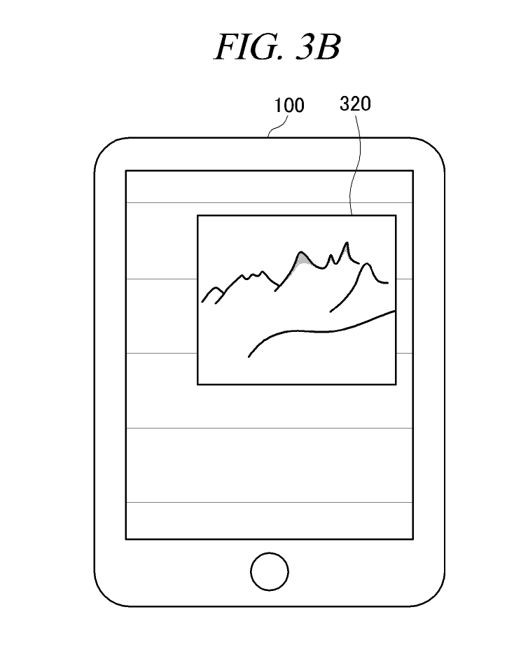

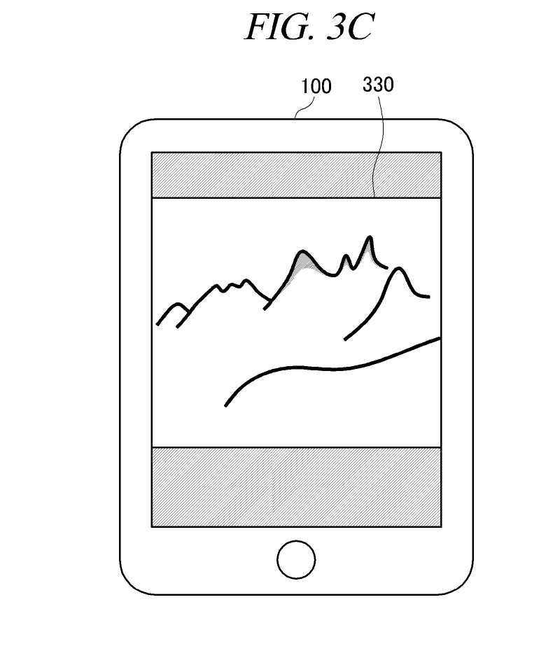

FIGS. 3A to 3C show examples of screenshots of a display of user device 100 that may display a camera viewfinder 310, 320 or 330 within a document, arranged in accordance with at least some embodiments described herein. Reference may be made to the embodiments depicted and described with reference to FIGS. 1-2.

As depicted in FIG. 3A, user device 100 may be configured to display at least portions of a document while displaying camera viewfinder 310 in a determined area within the document. By way of example, but not limitation, camera viewfinder 310 may show adjusted picture signal 210 as described in FIG. 2B. According to the example of FIG. 3A, since at least portions of a document with camera viewfinder 310 is displayed in a display of user device 100, a user of user device 100 may be able prepare and/or edit the document while viewing camera viewfinder 310.

In another example, as depicted in FIG. 3B, user device 100 may be configured to display an enlarged portion of the document, including the determined area in which to place the captured picture, while displaying camera viewfinder 320 in the determined area. According to the example of FIG. 3B, since camera viewfinder 310 is displayed as being enlarged on user device 100, user device 100 may provide a better view of camera viewfinder 310 to the user of user device 100 and the user of user device 100 may be able to adjust the camera focus on the subject more easily. The displaying of the enlarged part may revert to a previous vantage point (e.g., a displaying at least portions of the entire document) after capturing a picture and/or inserting the picture into the determined area of the document.

In yet another example, as depicted in FIG. 3C, upon determining the area in which to insert a future picture, user device 100 may be configured to display camera viewfinder 330 only, in which an adjusted picture signal (such as, for example, adjusted picture signal 210 of FIG. 2B) may be shown in accordance with an aspect ratio of the determined area. Further, user device 100 may be configured to display at least portions of the entire document after capturing a picture and/or inserting the picture into the determined area of the document.

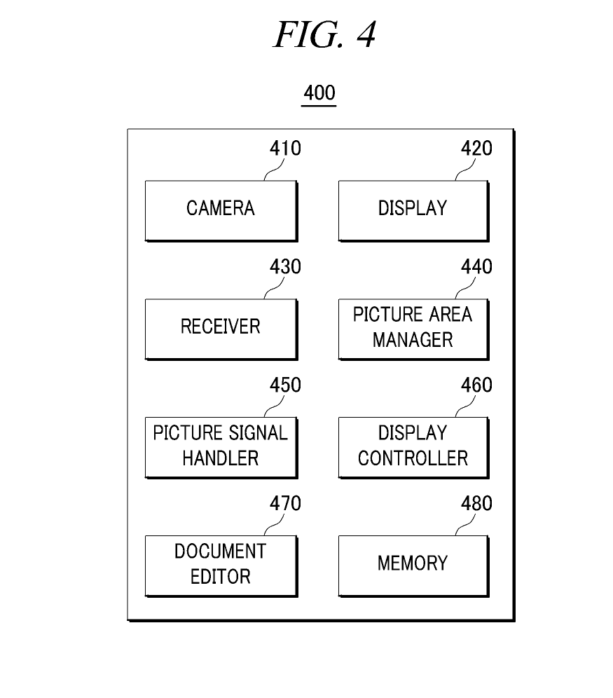

FIG. 4 shows a block diagram of an example architecture of a user device 400 configured to implement a photo insertion scheme, arranged in accordance with at least some embodiments described herein. User device 400 may correspond to the user device described with reference to FIGS. 1 and 2 above, and reference may be made to the embodiments depicted and described with reference to FIGS. 1 and 2.

As depicted, user device 400 may include a camera 410, a display 420, a receiver 430, a picture area manager 440, a picture signal handler 450, a display controller 460, a document editor 470 and a memory 480. Although illustrated as discrete components, various components may be divided into additional components, combined into fewer components, or eliminated while being contemplated within the scope of the disclosed subject matter. It will be understood by those skilled in the art that each function and/or operation of the components may be implemented, individually and/or collectively, by a wide range of hardware, software, firmware, or virtually any combination thereof

Camera 410 may be configured to capture a picture of the subject, and the captured picture may be provided to document editor 470. Further, camera 410 may be configured to capture and generate a picture signal of a subject located in front of camera 410, and the generated picture signal may be provided to picture signal handler 450.

Display 420 may be configured to receive an instruction and an image signal from display controller 460 and display the received image signal based on the received instruction to display the received image signal. Although camera 410 and display 420 are depicted as a part of user device 400 in FIG. 4, in some other embodiments, camera 410 and/or display 420 may be operatively coupled to user device 400 as a separate device.

Receiver 430 may be configured to receive a user input to insert a picture into a document. By way of example, but not limitation, the user input may include a selection or a click of camera button 111 (by a finger touch on the display surface or a mouse click in the GUI of the document editor program) as described with reference to FIG. 1A above. In some embodiments, receiver 430 may be further configured to receive another user input to determine an area (such as, for example, area 130 in FIG. 1A) in which to insert the future picture. By way of example, but not limitation, the other user input may include a pointing-and-dragging input as described with reference to FIG. 1A above.

Picture area manager 440 may be configured to determine an area (such as, for example, area 130 in FIG. 1A) in which to insert the future picture. In some embodiments, the determination may be based on the user input received by receiver 430 (such as, for example, the user input of two points 121 and 122). Further, picture area manager 440 may be configured to find an aspect ratio of the determined area. By way of example, picture area manager 440 may obtain the aspect ratio by the calculation as described with reference to FIG. 1A and 2B above. The obtained aspect ratio of the determined area may be provided to picture signal handler 450. Alternatively and/or additionally, the user input may include a user specified shape other than a rectangle (such as, for example, a diamond, a circle, an ellipse, a triangle, a user-drawn shape, etc.), picture area manager 440 may be configured to determine the area in accordance with the user specified shape.

Picture signal handler 450 may be configured to receive the picture signal from camera 410 and adjust the received picture signal based, at least in part, on the aspect ratio obtained by picture area manager 440. In some embodiments, picture signal handler 450 may be configured to crop the received picture signal in accordance with a user specified shape. By way of example, the user specified shape may include, but not limited thereto, a rectangle, a diamond, a circle, an ellipse, a triangle and a user-drawn shape.

Display controller 460 may be configured to instruct display 420 to display a camera viewfinder (such as, for example, camera viewfinder 140 in FIG. 1B) in the determined area. By way of example, but not limitation, display controller 460 may be configured to instruct display 420 to display the adjusted picture signal from picture signal handler 450 in the determined area.

Document editor 470 may be configured to receive the captured picture from camera 410 and insert the captured picture into the determined area within the document. Although document editor 470 is described as a separate component from picture area manager 440, picture signal handler 450 and display controller 460 in FIG. 4, in some other embodiments, at least one of picture area manager 440, picture signal handler 450 and display controller 460 may be a part of document editor 470. Memory 480 may be configured to store the document together with the captured picture inserted into the determined area within the document.

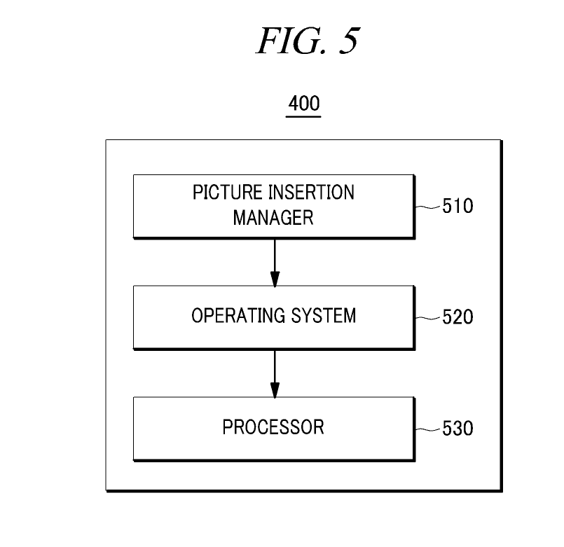

FIG. 5 shows a block diagram of another example architecture of user device 400 to implement a picture insertion scheme, arranged in accordance with at least some embodiments described herein. Reference may be made to the embodiments depicted and described with reference to FIGS. 1 to 4.

As depicted, user device 400 may include an picture insertion manager 510, an operating system 520 and a processor 530. Picture insertion manager 510 may be adapted to operate on operating system 520 such that the picture insertion scheme, as described herein, may be provided. Operating system 520 may allow picture insertion manager 510 to manipulate processor 530 to implement the picture insertion scheme as described herein.

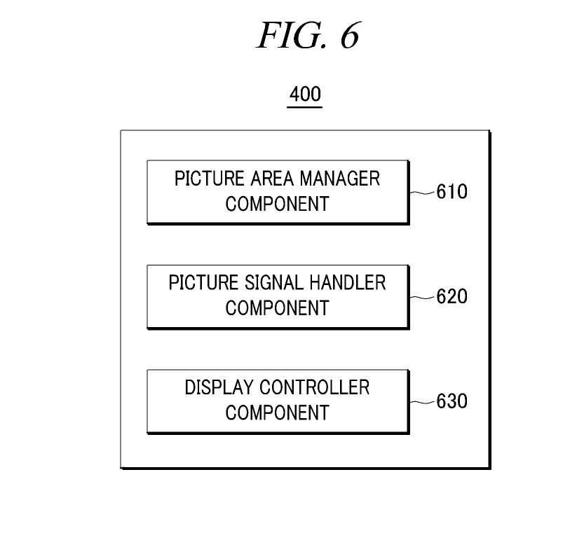

FIG. 6 shows a block diagram of an example architecture of picture insertion manager 510 to implement a picture insertion scheme, arranged in accordance with at least some embodiments described herein. Reference may be made to the embodiments depicted and described with reference to FIGS. 1 to 5.

As depicted, picture insertion manager 510 may include a picture area manager component 610, a picture signal handler component 620 and a display controller component 630. Picture area manager component 610 may be adapted to determine an area within a document in which to insert a future picture, in accordance with various example methods as described above. Picture signal handler component 620 may be adapted to adjust a picture signal from a camera, in accordance with various example methods as described above. Display controller component 630 may be adapted to instruct a display to display the adjusted picture signal as a camera viewfinder in the determined area within the document, in accordance with various example methods as described above.

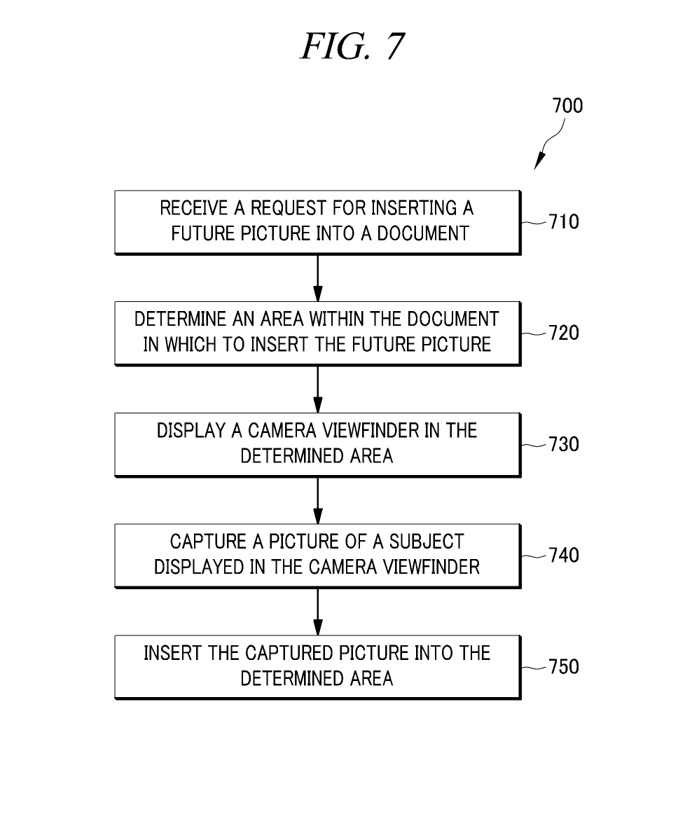

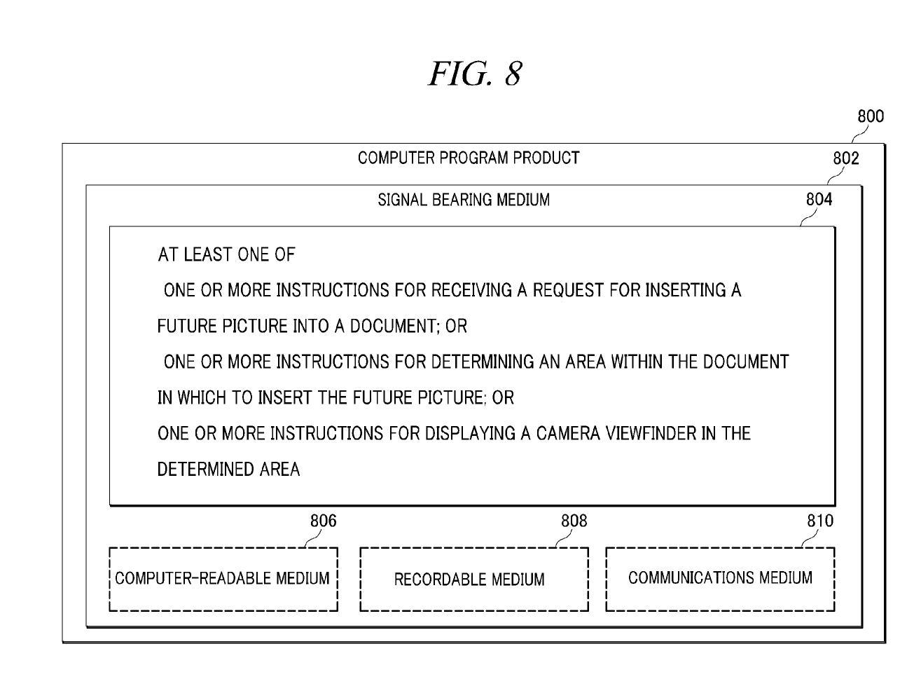

FIG. 7 shows an example flow diagram of a process to implement a picture insertion scheme, arranged in accordance with at least some embodiments described herein.

Process 700 may be implemented by a user device such as user device 400 including at least some of camera 410, display 420, receiver 430, picture area manager 440, picture signal handler 450, display controller 460, document editor 470 or memory 480. Process 700 may also be implemented by computer programs or program modules that may be adapted to provide a picture insertion scheme and hosted by user device 400, such as picture insertion manager 510 including picture area manager component 610, picture signal handler component 620 and display controller component 630. Thus, reference may be made to the embodiments depicted and described with reference to FIGS. 1-6. Process 700 may include one or more operations, actions, or functions as illustrated by one or more blocks 710, 720, 730, 740 and/or 750. Although illustrated as discrete blocks, various blocks may be divided into additional blocks, combined into fewer blocks, or eliminated, depending on the desired implementation. Processing may begin at block 710.

At block 710 (Receive a Request for Inserting a Future Picture into a Document), user device 400 and/or receiver 430 may receive a request for inserting a picture into a document. In some embodiments, user device 400 may further receive a user input to determine an area in which to insert the picture. Processing may continue from block 710 to block 720.

At block 720 (Determine an Area within the Document in Which to Insert the Future Picture), user device 400 and/or picture insertion manager 510 may determine the area in which to insert the picture based, at least in part, on the user input. In some embodiment, user device 400 and/or picture insertion manager 510 may find an aspect ratio of the determined area. Processing may continue from block 720 to block 730.

At block 730 (Display a Camera Viewfinder in the Determined Area), user device 400 and/or picture insertion manager 510 may display a camera viewfinder in the determined area within the document. In some embodiments, user device 400 and/or picture insertion manager 510 may adjust a picture signal from camera 410 based on the aspect ratio of the determined area and display the adjusted picture signal as the camera viewfinder. Processing may continue from block 730 to block 740.

At block 740 (Capture a Picture of a Subject Displayed in the Camera Viewfinder), user device 400 and/or camera 410 may capture a picture of a subject displayed in the camera. The captured picture may have the same aspect ratio with that of the determined area. Processing may continue from block 740 to block 750.

At block 750 (Insert the Captured Picture into the Determined Area), user device 400 and/or document editor 470 may insert the captured picture into the determined area within the document. As such, the camera viewfinder is provided within the document, the user of user device 400 may be able to easily capture and insert a picture into the document at an appropriate area and with an appropriate size and aspect ratio.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

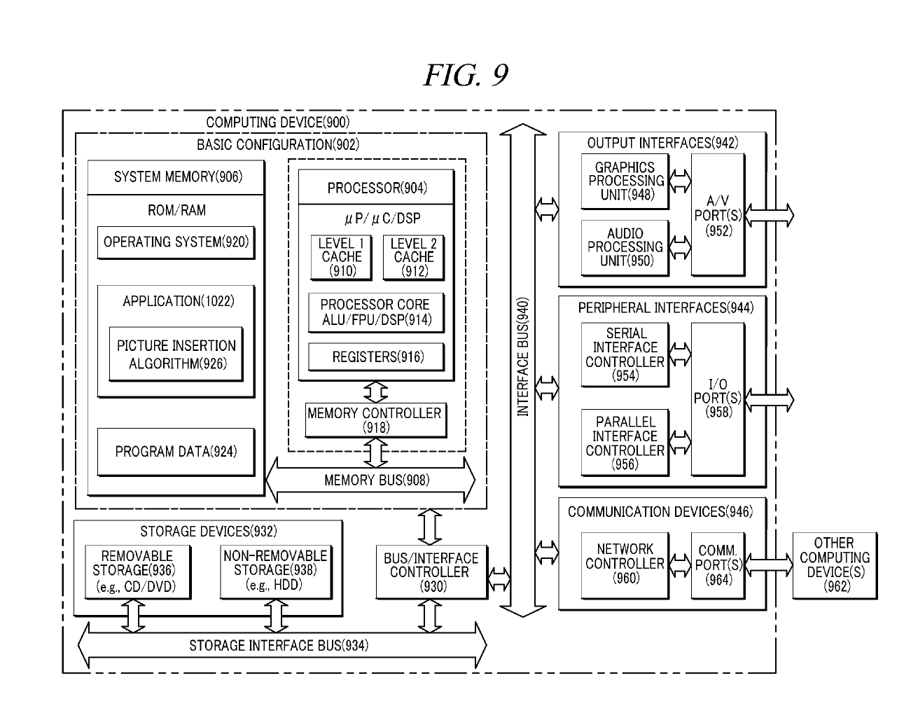

FIG. 8 illustrates an example computer program product 800 that may be utilized to implement a picture insertion scheme, arranged in accordance with at least some embodiments described herein.

As depicted, program product 800 may include a signal bearing medium 802. Signal bearing medium 802 may include one or more instructions 804 that, when executed by, for example, a processor of user device 400 may provide the functionality described above with respect to FIGS. 1-7. By way of example, instructions 804 may include: one or more instructions for receiving a request for inserting a future picture into a document; or one or more instructions for determining an area within the document in which to insert the future picture; or one or more instructions for displaying a camera viewfinder in the determined area.

In some implementations, signal bearing medium 802 may encompass a computer-readable medium 806, such as, but not limited to, a hard disk drive, a CD, a DVD, a digital tape, memory, etc. In some implementations, signal bearing medium 802 may encompass a recordable medium 808, such as, but not limited to, memory, read/write (R/W) CDs, R/W DVDs, etc. In some implementations, signal bearing medium 802 may encompass a communications medium 810, such as, but not limited to, a digital and/or an analog communication medium (e.g., a fiber optic cable, a waveguide, a wired communications link, a wireless communication link, etc.). Thus, for example, program product 800 may be conveyed to one or more modules of electronic device 120 by an RF signal bearing medium 802, where the signal bearing medium 802 is conveyed by a wireless communications medium 810 (e.g., a wireless communications medium conforming with the IEEE 802.11 standard).

FIG. 9 is a block diagram illustrating an example computing device 900 that may be utilized to implement a picture insertion scheme, arranged in accordance with at least some embodiments described herein.

In a very basic configuration 902, computing device 900 typically includes one or more processors 904 and a system memory 906. A memory bus 908 may be used for communicating between processor 904 and system memory 906.

Depending on the desired configuration, processor 904 may be of any type including but not limited to a microprocessor (μP), a microcontroller (μC), a digital signal processor (DSP), or any combination thereof. Processor 904 may include one or more levels of caching, such as a level one cache 910 and a level two cache 912, a processor core 914, and registers 916. An example processor core 914 may include an arithmetic logic unit (ALU), a floating point unit (FPU), a digital signal processing core (DSP Core), or any combination thereof. An example memory controller 918 may also be used with processor 904, or in some implementations memory controller 918 may be an internal part of processor 904.

Depending on the desired configuration, system memory 906 may be of any type including but not limited to volatile memory (such as RAM), non-volatile memory (such as ROM, flash memory, etc.) or any combination thereof. System memory 906 may include an operating system 920, one or more applications 922, and program data 924.

Application 922 may include an picture insertion algorithm 926 that may be arranged to perform the functions as described herein including the actions described with respect to user device 400 architecture as shown in FIGS. 4-6 or including the actions described with respect to the flow chart shown in FIG. 7. Program data 924 may include any data that may be useful for providing the photo insertion scheme as is described herein. In some examples, application 922 may be arranged to operate with program data 924 on an operating system 920 such that the photo insertion scheme as described herein may be provided.

Computing device 900 may have additional features or functionality, and additional interfaces to facilitate communications between basic configuration 902 and any required devices and interfaces. For example, a bus/interface controller 930 may be used to facilitate communications between basic configuration 902 and one or more data storage devices 932 via a storage interface bus 934. Data storage devices 932 may be removable storage devices 936, non-removable storage devices 938, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 906, removable storage devices 936 and non-removable storage devices 938 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 900. Any such computer storage media may be part of computing device 900.

Computing device 900 may also include an interface bus 940 for facilitating communication from various interface devices (e.g., output devices 942, peripheral interfaces 944, and communication devices 946) to basic configuration 902 via bus/interface controller 930. Example output devices 942 include a graphics processing unit 948 and an audio processing unit 950, which may be configured to communicate to various external devices such as a display or speakers via one or more A/V ports 952. Example peripheral interfaces 944 include a serial interface controller 954 or a parallel interface controller 956, which may be configured to communicate with external devices such as input devices (e.g., keyboard, mouse, pen, voice input device, touch input device, etc.) or other peripheral devices (e.g., printer, scanner, etc.) via one or more I/O ports 958. An example communication device 946 includes a network controller 960, which may be arranged to facilitate communications with one or more other computing devices 962 over a network communication link via one or more communication ports 964.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method performed under control of a user device, the method comprising:
receiving a request for inserting a future picture into a document;
determining an area within the document in which to insert the future picture; and
displaying a camera viewfinder in the determined area, the camera view finder operable to display an image of a subject for capturing as a picture.

2. The method of claim 1, further comprising:
capturing a picture of the subject when displayed in the camera viewfinder; and
inserting the captured picture into the determined area.

3. The method of claim 1, wherein the determining comprises finding an aspect ratio of the determined area.

4. The method of claim 3, further comprising:
adjusting a picture signal from a camera based, at least in part, on the aspect ratio.

5. The method of claim 1, wherein the determining includes determining the area within the document in accordance with a user specified shape.

6. The method of claim 5, wherein the user specified shape is selected from a group consisting of a rectangle, a diamond, a circle, an ellipse, a triangle and a user-drawn shape.

7. The method of claim 4, wherein the displaying includes displaying the adjusted picture signal in the determined area.

8. The method of claim 1, further comprising:
receiving a pointing-and-dragging input on the document,
wherein the determining of the area is based, at least in part, on the pointing-and-dragging input.

9. A document editor apparatus, comprising:
a receiver configured to receive an instruction to insert a future picture into a document;
a picture area manager configured to determine an area within the document in which to insert the future picture; and
a display controller configured to instruct a display to display a camera viewfinder in the determined area, the camera view finder operable to display an image of a subject for capturing as a picture.

10. The document editor apparatus of claim 9, further comprising:
a camera configured to capture a picture of the subject when displayed in the camera viewfinder.

11. The document editor apparatus of claim 10, further comprising:
a document editor configured to insert the captured picture into the determined area.

12. The document editor apparatus of claim 9, wherein the picture area manager is further configured to find an aspect ratio of the determined area.

13. The document editor apparatus of claim 12, further comprising:
a picture signal handler configured to receive a picture signal from a camera and adjust the received picture signal based, at least in part, on the aspect ratio,
wherein the display controller is further configured to instruct the display to display the adjusted picture signal in the determined area.

14. The document editor apparatus of claim 9, wherein the picture area manager is further configured to determine the area within the document in accordance with a user specified shape.

15. The document editor apparatus of claim 14, wherein the user specified shape is selected from a group consisting of a rectangle, a diamond, a circle, an ellipse, a triangle and a user-drawn shape.

16. The document editor apparatus of claim 9, wherein the receiver is further configured to receive a pointing-and-dragging input on the document, and
wherein the picture area manager is further configured to determine the area within the document based, at least in part, on the pointing-and-dragging input.

17. A computer-readable storage medium having stored thereon computer-executable instructions that, in response to execution, cause a user device to perform operations, comprising:
determining an area within a document in which to insert a future picture;
finding an aspect ratio of the determined area;
adjusting a picture signal from a camera based, at least in part, on the aspect ratio; and
displaying, in the determined area, a camera viewfinder showing the adjusted picture signal, the camera view finder operable to display an image of a subject for capturing as a picture.

18. The computer-readable storage medium of claim 17, wherein the operations further comprising:
capturing a picture of the subject when displayed in the camera viewfinder; and
inserting the captured picture into the determined area.

19. The computer-readable storage medium of claim 17, wherein the adjusting includes cropping the picture signal in accordance with the aspect ratio.

20. The computer-readable storage medium of claim 17, wherein the operations further comprising:
receiving a pointing-and-dragging input on the document,
wherein the determining of the area is based, at least in part, on the pointing-and-dragging input.
